(19) United States
(12) Patent Application Publication
(10) Pub. No.: US 2004/0255513 A1
(43) Pub. Date: Dec. 23, 2004

(54) System for growing vegetation on an open body of water

(76) Inventor: Daniel F. Becker, Baton Rouge, LA (US)

Correspondence Address: SIEBERTH & PATTY, 2924 BRAKLEY DRIVE SUITE A 1, BATON ROUGE, LA, 70816

(21) Appl. No.: 10/462,856

(22) Filed: Jun. 17, 2003

(51) Int. Cl. A01G 9/02

(52) U.S. Cl. 47/65.9

(57) ABSTRACT

A buoyant system for restoring aquatic vegetation on an open body of water is described. The buoyant system is preferably equipped with flotation apparatus and a matrix sized and configured to support the vegetation, with the matrix being connected to the flotation apparatus. Also included is water-contacting means for raising and lowering the matrix relative to the surface of the water when the system is in use, so that at least a portion of a root region of the vegetation is brought into and out of contact with the water, on a periodic and repetitive basis, during use of the system.

### FIELD OF THE INVENTION

This invention relates generally to systems for cultivating terrestrial organisms in an aquatic environment and more particularly to systems for restoring vegetation in marshland or similar areas near open bodies of water.

### BACKGROUND

Natural healthy marsh vegetation has many beneficial functions. Some of these functions include sediment capture, nutrient transformation, erosion control, and animal habitat. Organic soils built up by sediment deposits of such vegetation hold moisture longer than deposits of sand or clay. Such vegetation can also function as a nutrient source for various animals and hatching site for fish eggs.

As a result of the presence of man and commercial development, many marshlands have recently experienced ecological damage. For example, as a result of exploration for oil and gas deposits, an extensive network of oil field canals extend over many acres of open water marshland in the Gulf Coast region of the United States. I believe that these manmade canals have significantly altered the hydrology of the marsh and increased coastal erosion due to unnatural changes in tidal water exchange. Various projects have been formulated to reduce the effects of unnatural tidal fluctuations. These projects have included activities such as construction of weirs, selective dredging, and gapping of spoil banks along the canals' edges. Another approach to reclaiming and restoring wetlands and marshlands which have suffered tidal erosion has been to simply fill in eroded areas with dredged sediments and plant plugs of grass. This approach is problematic in that either the sediment is excessively dry a majority of the time or surrounding areas are inadvertently flooded for long periods during storm tide situations. These conditions are not conducive to production of a floating mass of vegetation, also known as a “floton,” which can function as a living filtration system for a healthy marsh.

A need therefore exists for a system to establish conditions that will sustain communities of aquatic vegetation so that healthy marsh vegetation can be cultivated and established or reestablished.

### SUMMARY OF THE INVENTION

The present invention meets this and other needs by providing, among other things, a buoyant system for growing vegetation on an open body of water. The system comprises (A) flotation apparatus, (B) a matrix sized and configured to support the vegetation, the matrix being connected to the flotation apparatus, and (C) water-contacting means for raising and lowering the matrix relative to the surface of the water when the system is in use. In this way, at least a portion of a root region of the vegetation is brought into and out of contact with the water, on a periodic and repetitive basis, during use of the system.

Repeated, frequent oscillation of the matrix relative to the surface of the water, so that the roots of the vegetation are repeatedly exposed to aquatic conditions and then to air, causes a beneficial stimulation of growth in the vegetation. This stimulated growth of the vegetation carries the added benefit that marsh restoration projects can be completed within unexpectedly short time frames and with great economic savings. Without being bound by theory, it is believed that, due at least in part to a cycle of reduced and oxygenated conditions, also known as redox reactions, quick oxidizing of nutrients promotes uptake of the nutrients by the vegetation with its resultant fast growth.

In a preferred embodiment of the invention an automated controller is used for controlling the cycle time of the water-contacting means.

Another preferred embodiment of the invention provides a method for restoring aquatic marsh vegetation in situ on an open body of water. The method comprises (A) floating on the body of water at least one buoyant system which comprises at least one flotation apparatus connected to a matrix, sized and configured to support the vegetation, and water-contacting means for raising and lowering the matrix relative to the surface of the water, (B) suspending marsh vegetation within the matrix, and (C) periodically and repetitively raising and lowering the matrix relative to the surface of the water by action of the water-contacting means so that a varying level of water is provided to the at least a portion of the root region of the vegetation.

These and other embodiments, advantages, and features of this invention will be apparent from the following description, accompanying drawings and appended claims.

### BRIEF DESCRIPTION OF THE DRAWINGS

FIG. 1A is a perspective view of an embodiment of the invention floating on an open body of water.

FIG. 1B is a perspective view of the buoyant system of FIG. 1A in a raised position.

FIG. 2A is a cross-sectional view of the buoyant system of FIG. 1A in a lowered position.

FIG. 2B is a cross-sectional view of an embodiment of the invention showing flotation apparatus and water-controlling means.

FIG. 2C is a cross-sectional view of another embodiment of the invention showing flotation apparatus and water-controlling means.

FIG. 2D is a cross-sectional view of another embodiment of the invention showing flotation apparatus and water-controlling means.

FIG. 3A is a cross-sectional view of an open body of water with an embodiment of the invention floating thereon in a lowered position.

FIG. 3B is a cross-sectional view of an open body of water with an embodiment of the invention floating thereon in a raised position.

FIG. 3C is a cross-sectional view of an embodiment of the invention showing water-contacting means and flotation apparatus.

FIG. 3D is a cross-sectional view of another embodiment of the invention showing water-contacting means and flotation apparatus.

FIG. 4A is a cross-sectional view of an embodiment of the invention floating on an open body of water which shows the matrix in a raised position.

FIG. 4B is a cross-sectional view of another embodiment of the invention floating on an open body of water which shows the matrix in a raised position.

FIG. 4C is a cross-sectional view of an embodiment of the invention floating on an open body of water which shows the buoyant system of the invention in a raised position.

FIG. 5A is a cross-sectional view of an embodiment of the invention shown floating on an open body of water with the matrix in a raised position.

FIG. 5B shows the matrix of FIG. 5A in a lowered position.

FIG. 5C is a view of the embodiment of the invention of FIG. 5B showing the matrix in a raised position and the vegetation in a mature stage of growth.

FIG. 5D is a view of the embodiment of the invention of FIG. 5C with the buoyant system removed except for the matrix and vegetation.

FIG. 5E is a view of the embodiment of the invention of FIG. 5D with at least two banks of the body of water removed.

FIG. 5F shows the embodiment of the invention of FIG. 5E after the practice of an embodiment the invention has provided healthy aquatic marsh vegetation.

FIG. 6 is a perspective view of a plurality of buoyant systems linked together.

In each of the above figures, like numerals or letters are used to refer to like or functionally like parts among the several figures.

### DETAILED DESCRIPTION OF THE INVENTION

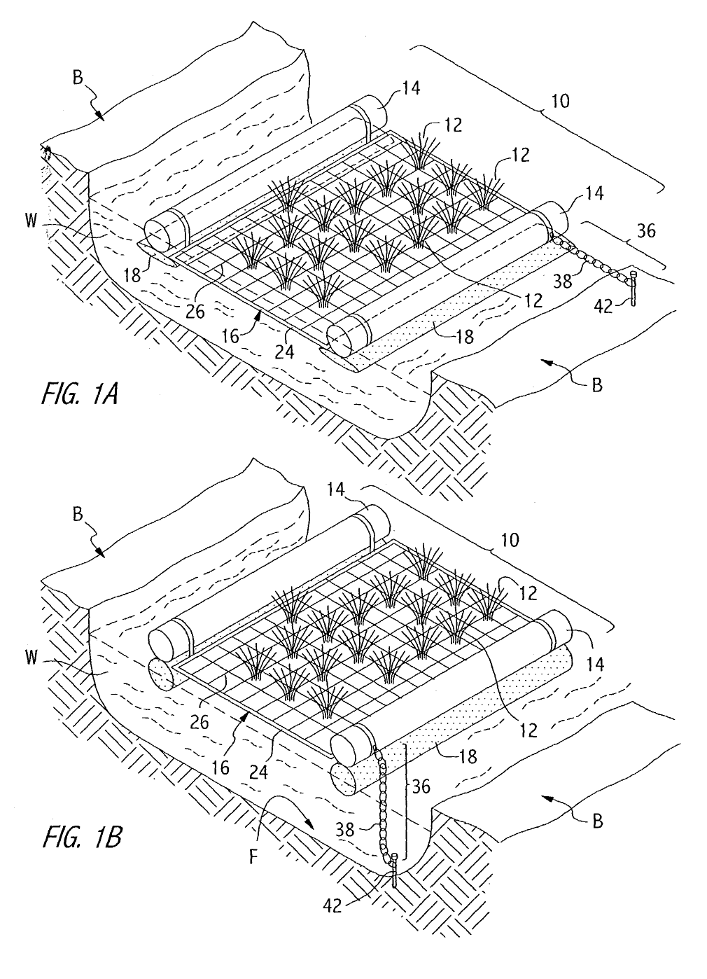

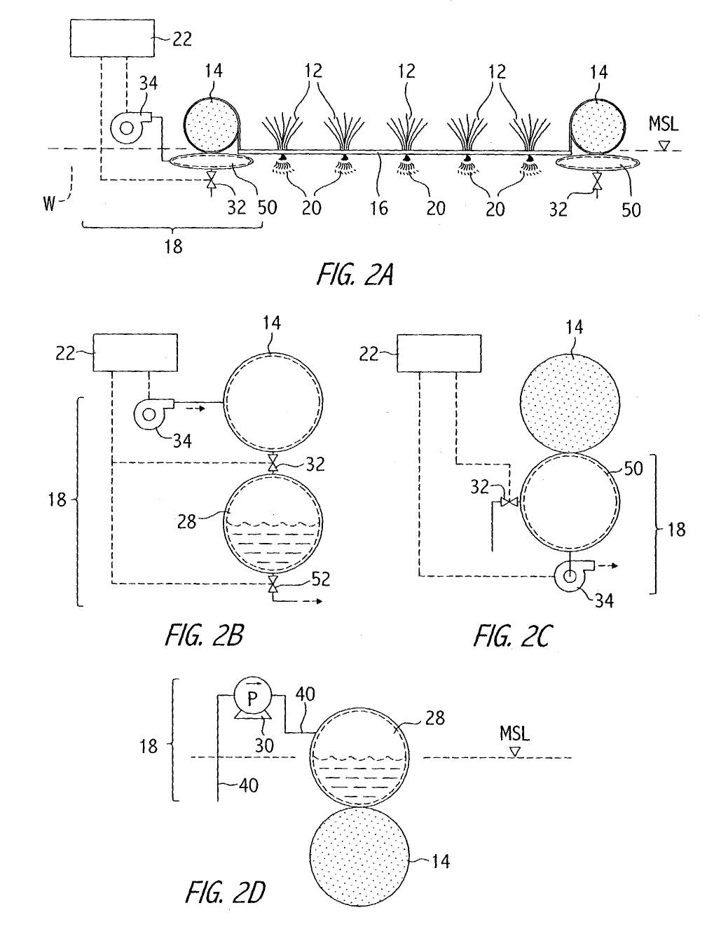

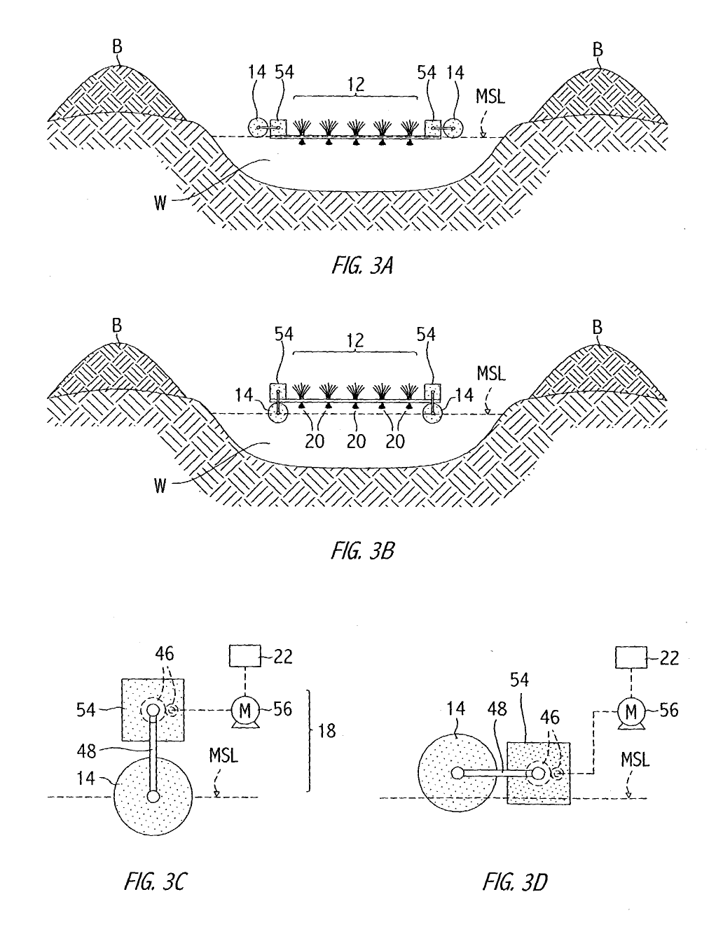

It will now be appreciated from FIGS. 1A and 1B that a preferred embodiment of this invention comprises a buoyant system 10 which system comprises flotation apparatus 14, matrix 16 and water-contacting means 18. As shown in FIG. 1A, flotation apparatus 14 comprises pontoons constructed of cylindrical STYROFOAM™ foam. Suspended and attached to flotation apparatus 14, matrix 16 is sized and configured to support vegetation 12. Matrix 16 is comprised of an open frame 24 that is open above and below a material 26 which extends across frame 24 and supports vegetation 12 so that at least a portion of a root region 20 of vegetation 12 (shown in FIG. 2A) can pass through material 26 and contact water W of the open body of water during one phase of operation of the invention. Although vegetation 12 can be any desirable type of aquatic plant, in a preferred embodiment of the invention, vegetation 12 is Spartina alterniflora, also known as salt marsh cord grass.

Also shown in FIG. 1A is anchoring means 36 which is comprised of a chain 38 and a stake 42. Chain 38 is attached to flotation apparatus 14 and to a stake 42 embedded in a bank B of the open body of water. Alternatively, anchoring means 36 can be attached to the floor F of the body of water as shown in FIG. 1B. Action of anchoring means 36 restricts lateral motion of buoyant system 10 on the surface of the water body.

As may be seen from FIG. 2A, buoyant system 10 is sized and configured to allow root region 20 of vegetation 12 to be brought into contact with water W. Water-contacting means 18, is shown comprising a balloon structure 50 in a deflated state, an air compressor 34, attached to balloon structure 50 and valve 32 which enables air to exit balloon 50. Water-contacting means 18, is sized and configured to have a gas, such as air, transferred into balloon structure 50, by compressor 34 and then to have valve 32 open to allow air to exit balloon structure 50. In this way, matrix 16 is raised and lowered relative to the surface of the water. Actions of water-contacting means 18 and its component elements are controlled by automated controller 22. In the embodiment of the invention as shown, flotation apparatus 14 maintains enough buoyant force to keep the matrix substantially at the surface of the water when balloon structure 50 is essentially devoid of air. MSL refers to mean sea level.

FIGS. 2B, 2C and 2D depict other preferred embodiments of the invention in more detail, each having differing water-contacting means 18. In FIG. 2B water-contacting means 18 comprises an air compressor 34, a ballast tank 28, linking valve 32, and bleed valve 52. Air compressor is in fluid communication with a flotation apparatus 14, depicted herein as an air tank. Flotation apparatus 14 is in fluid communication with ballast tank 28 by way of linking valve 32. Bleed valve 52 allows fluid communication between ballast tank 28 and the water. Automated controller 22 controls activation and deactivation of air compressor 34 and valves 32,52. In order to cause flotation apparatus 14 to be raised in the water, with resultant raising of matrix 16 (shown, i.e., in FIG. 1A), automated controller 22 (1) directs activation of air compressor 34 to force compressed air into flotation apparatus 14, (2) directs opening of linking valve 32 between flotation apparatus 14 and ballast tank 28 thus allowing passage of air into ballast tank 28, and (3) directs opening of valve 52 to allow a portion of the water in ballast tank 28 to be forced out through bleed valve 52. Air compressor 34 remains active until the proper level of the buoyant system, relative to the surface of the water, is reached. Once the desired level is reached, automated controller 22 causes linking valve 32 and bleed valve 52 to close. The buoyant system will be maintained in this raised position for the proper preset interval of time so that the root region of the vegetation is lifted out of the water and exposed to air. During the lowering cycle of operation of water-controlling means 18, automated controller 22 controls the components of water-controlling means 18 to cause (1) air compressor 34 to be deactivated, (2) valve 32 to open and (3) valve 52 to open allowing water to at least partially fill ballast tank 28 thus causing the buoyant system to be lowered in the water. Thus, at least a portion of the root region of the vegetation is immersed in the water.

FIG. 2C shows a water-contacting means 18 and a flotation apparatus 14. In this embodiment of the invention, flotation apparatus 14 comprises a solid STYROFOAM™ foam structure. Water-contacting means 18 comprises a balloon structure 50, valve 32 and air compressor 34. Automated controller 22 controls activation and deactivation of valve 32 and air compressor 34, so as to periodically and repetitively inflate and deflate balloon structure 50. As shown, valve 32 is closed and air compressor 34 is activated by controller 22 so that balloon structure 50 inflates and causes the buoyant system to be raised relative to the surface of the water. In the lowering cycle (not shown) valve 32 opens to bleed off air and air compressor 34 deactivates. Weight of the buoyant system causes balloon structure 50 to deflate, and the buoyant system lowers relative to the water surface until the buoyant force exerted by flotation apparatus 16 causes the buoyant system to stabilize on the surface of the water body.

In FIG. 2D positions of flotation apparatus 14, constructed of solid STYROFOAM™ foam and ballast tank 28 are reversed, relative to each other. In this embodiment of the invention, water-containing means 18 comprises a pump 30, conduit 40 and ballast tank 28. During the lowering operation, pump 30 causes water to be pumped into ballast tank 28, causing the lowering of the buoyant system. During the raising operation, pump 30 causes water to be pumped out of the ballast tank 28, thus allowing the buoyant system to rise.

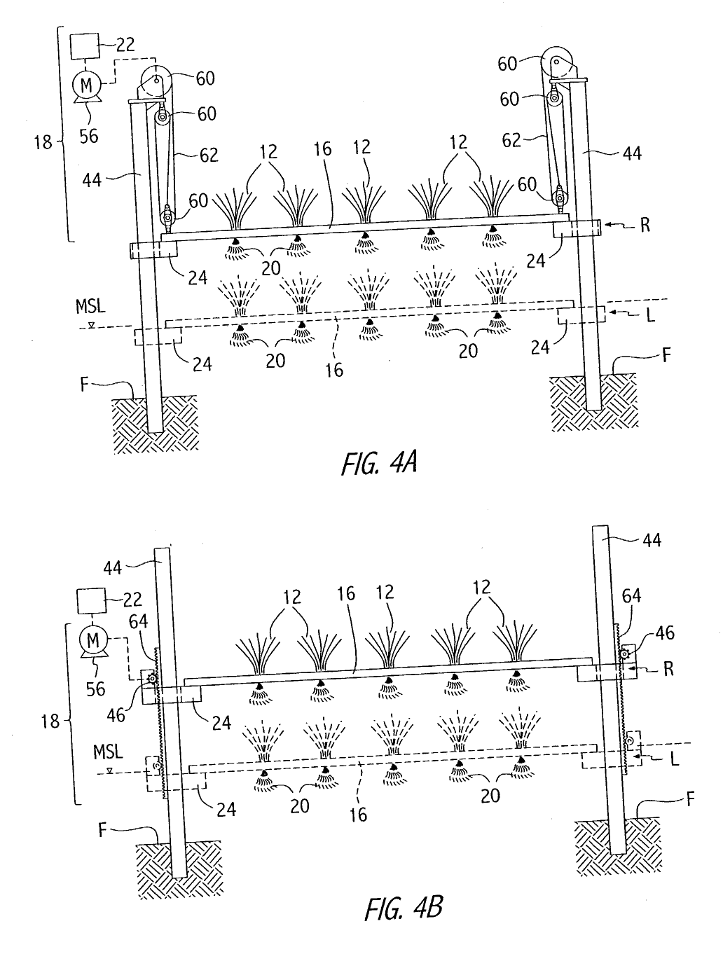

FIGS. 3A, 3B, 3C, and 3D depict a water-contacting means 18 which comprises a flotation device 54 composed of solid STYROFOAM™ foam. Water-contacting means 18 also comprises motor 56 for driving gears 46 and connector arm 48, which connector arm 48 is connected to both flotation device 54 and flotation apparatus 14, which is also constructed of solid STYROFOAM™ foam. When the buoyant system is in the lowered position as seen in FIGS. 3A and 3D, an automatic controller 22 controls activation and deactivation of motor 56 to cause gears 46,46 and connector arms 48,48 to rotate flotation apparatus 14 into an “outrigger” position relative to flotation device 54. In the raised position for the buoyant system, seen best in FIGS. 3B and 3C, the flotation apparatus 14 is forced into a vertical alignment with flotation device 54, thus causing root region 20 of vegetation 12 out of the water.

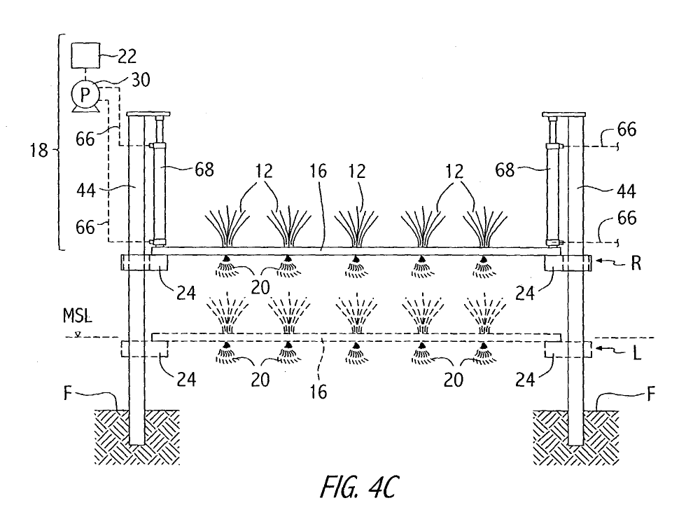

In yet another embodiment of the invention as seen in FIGS. 4A, 4B and 4C, water-contacting means 18 and frame 24 are connected to posts or pilings 44,44 which are embedded in the floor F of the open body of water. In FIG. 4A, water-contacting means 18 comprises a motor 56 and a system of ropes 62,62 and pulleys 60,60 for causing matrix 16 to move between raised position R and lowered position L. In FIG. 4B water-contacting means 18 comprises a motor 56, pinion gears 46 and a rack 64 which work in concert to also cause the cycling of matrix 16 between raised position R and lowered position L. As may be seen in FIG. 4C, water-contacting means 18 comprises a pump 30, hydraulic cylinders 68,68 and hydraulic lines 66,66. Automatic controller 22 controls action of pump 30 which causes hydraulic cylinders 68,68 to raise and lower matrix 16 between positions R and L. In this figure, as in others, MSL designates a typical mean sea level of the water level of the open body of water.

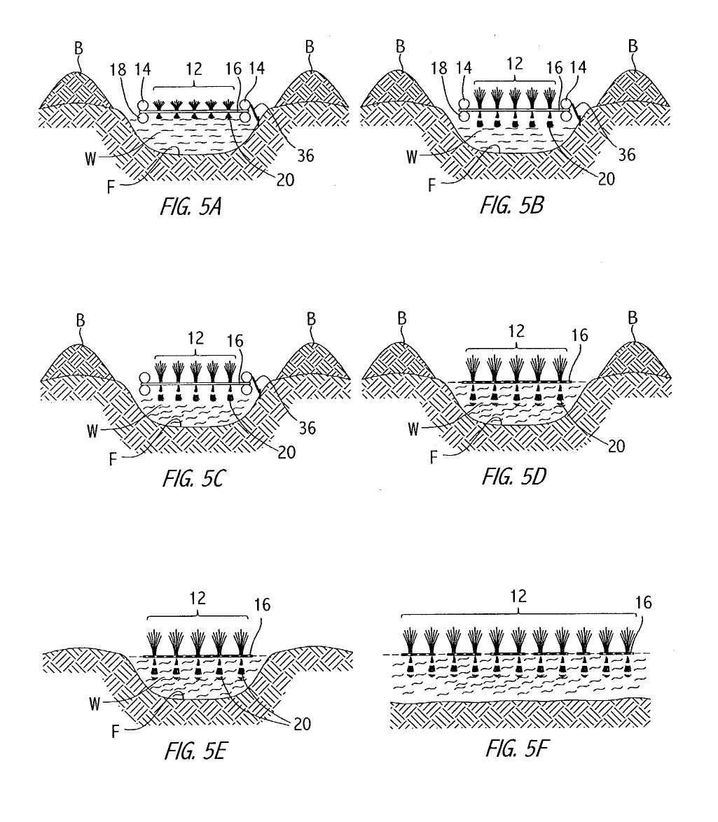

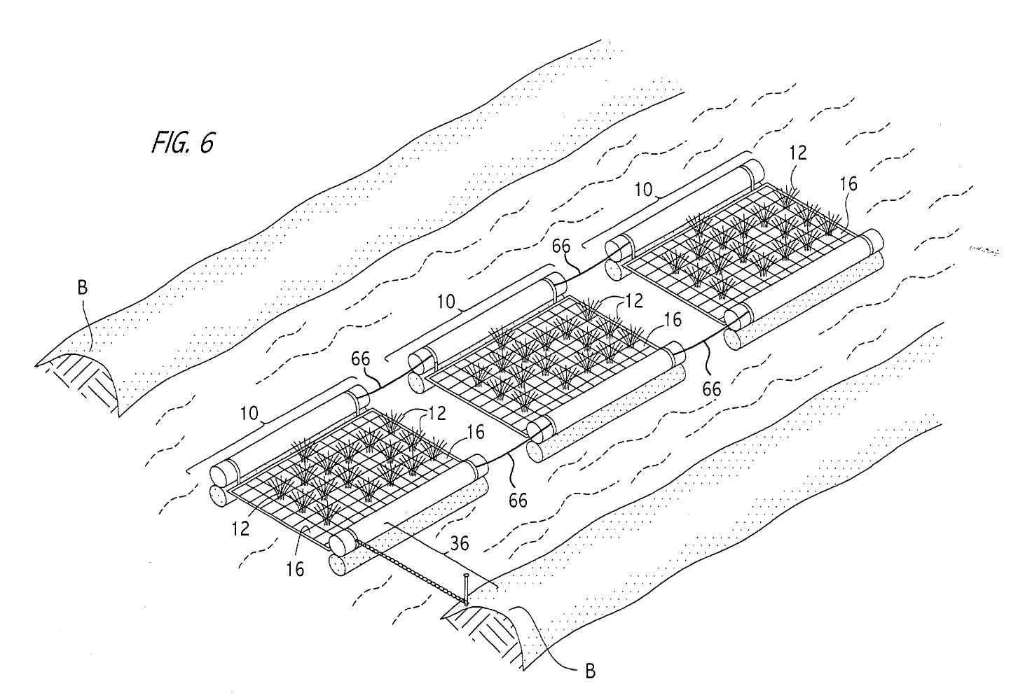

As illustrated in FIGS. 5A through 5C, a preferred embodiment of the invention is a method for restoring aquatic marsh vegetation in situ in an open body of water W, shown here as a canal. The method comprises floating on the body of water W at least one flotation apparatus 14 connected to a matrix 16, sized and configured to support vegetation 12, and water-contacting means 18 for raising and lowering matrix 16 relative to the surface of water W. Marsh vegetation 12 is suspended within matrix 16 and matrix 16 is periodically and repetitively raised and lowered relative to the surface of water W by action of water-contacting means 18. In this way a varying level of water is provided to at least a portion of root region 20 of vegetation 12.

FIGS. 5D through 5F depict another embodiment of the invention which comprises a method for restoring aquatic marsh vegetation in situ in an open body of water W, essentially in the same way as depicted above in the discussion of FIGS. 5A through 5D. As shown in FIGS. 5D through 5F, the buoyant system has been removed except for matrix 16 and vegetation 12, leaving aquatic marsh vegetation 12 floating on the body of water. Additionally, portions of the banks B,B have been removed to allow normal ebb and flow of tides which have been restricted by banks B,B. As vegetation 12 has matured, natural “litterfall” of leaves and stems from vegetation 12 has fallen to the floor F of the canal which tends to cause the canal to fill in over time with desirable organic soils.

FIG. 6 illustrates another preferred embodiment of the invention for restoring aquatic marsh vegetation in situ on an open body of water, in this figure illustrated as a canal. Vegetation 12 is disposed within a number of matrices 16,16 of a plurality of buoyant systems 10,10 as previously described. Buoyant systems 10,10 are linked together on the body of water by linking means 66,66 herein depicted as cables. Buoyant system 10 is shown anchored to bank B of the canal using anchoring means 36, herein a chain and stake attached to buoyant system 10. By provision of a plurality of buoyant systems, a large area of canal can be reclaimed and restored in a highly efficient manner.

The open body of water which is the object of the practice of this invention can be any lake, creek, swamp, marsh, pond, canal or system of canals that would be benefitted by establishment or restoration of healthy aquatic vegetation.

In a preferred embodiment of this invention the aquatic marsh vegetation which is disposed and cultivated in the buoyant system can be any variety of plant or grass which grows well in conditions where the vegetation's roots are periodically exposed to the aquatic environment and then exposed to the air. In the practice of a preferred embodiment of this invention, such periodic exposure is accomplished by raising and lowering the matrix relative to the surface of the water on which the buoyant system is floating, so that at least a portion of a root region of the vegetation is brought into and out of contact with the water, on a periodic and repetitive basis. Such conditions of exposure of the roots of aquatic vegetation to aquatic submersion and air drying occur naturally in salt marsh environments which are subject to the ebb and flow of the tides, where such plants exist best at mean sea level (“MSL”). The raising and lowering of the plants constitutes a particularly beneficial feature of the invention since the plants are never left “high and dry,” but are always maintained at mean sea level. In previous attempts to address the problem of coastal erosion, one technique employed was to simply fill in the canals with some type of fill material, such as clay, and set out plants. Such a technique has proved to be unsuccessful for the reason that the roots of the plants are exposed to dry conditions for too long with resulting plant death. The present invention overcomes this drawback by cycling the periods of wet and dry conditions often enough to stimulate growth while ensuring sufficient time for the roots to be immersed in the water, similar to the natural ebb and flow of the tides. Such desirable inter-tidal plants are those which are commonly found in wetlands, which are inundated with water for significant periods of time. House plants will die from over-watering but the plants which grow in the marsh are capable of oxygenating their root zone by using “straw-like” tissue to transport oxygen from the leaf of the plant to the roots. Plants which grow well under “dry and flood” conditions generally grow more quickly than plants which are always flooded. It is to be understood that vegetation employed by embodiments of this invention can include several types of plants, and in particular certain grasses. Preferred types of plants which comprise the vegetation of the present invention which are capable of sustained and rapid growth in inter-tidal and marsh environments, include, but are not limited to, Spartina patens, Juncus roemerianus, and Spartina alterniflora, with Spartina alterniflora being of particular interest in the Gulf South region of the United States. An added feature of these grasses and plants is that they generally have high tolerance to salt water conditions. In addition these grasses can alter the salinity of the water in which they grow by moving salt from their root zone to their leaves.

When using the preferred buoyant system of this invention, the flotation apparatus can comprise any type of buoyant material or structure which tends to raise the buoyant system relative to the surface of the body of water in which the buoyant system is floating. Such flotation apparatus can be comprised of materials and devices such as, but not limited to: pontoons constructed of rigid cellular foam, such as STYROFOAM™ foam; pontoons made from fiberglass, metal, plastic or polyvinylchloride; inflatable bags; inflatable balloons; or structures sized and configured to have an appropriate gas, such as air, transferred into and out of the structure as the buoyant force exerted on the buoyant system is changed. In a preferred embodiment of the invention, pontoons are used. The pontoons can comprise telescoping elements so that the dimensions of the system can be increased for maximum area coverage of the surface of the water body with the matrix and vegetation. Flotation apparatus can have variable buoyancy. For example, in one preferred embodiment of the invention, the flotation apparatus comprises an inflatable bag attached to a gas compressor. As the weight of the system increases over time from the added weight of growing vegetation, together with any other type of added weight, e.g., barnacles, the buoyant force of the flotation apparatus can be increased by addition to the inflatable bag of a compressed gas, e.g., air. This ability to vary the buoyancy of the flotation apparatus can improve the capabilities of the buoyant system to maintain the efficient cycling action of the vegetation root area into and out of contact with the water.

The matrix of the present invention can comprise any suitable structure or material which is sized and configured to support the vegetation. Desirable types of matrix material can include, but are not limited to, mesh or woven material of organic or synthetic origin. In preferred embodiments of the invention, the matrix comprises a woven net of semi-porous organic material such as burlap, compressed peat with bagasse, woven bamboo or rock wool, with rock wool being most preferred.

Water-contacting means of this invention can be a wide variety of systems or components which cause the matrix holding the vegetation to be raised and lowered in a controlled fashion. Suitable water-contacting means can include, for example, one or more pumps in fluid communication with the flotation apparatus (e.g.,one or more ballast tanks) wherein the one or more pumps can cause fluid and/or a gas (e.g., air) to be transported into and out of the flotation apparatus so as to control the level of the ballast tank flotation. Water-contacting means can also include, for example, an outrigger system with a rotatable counterweight to the flotation apparatus and electric motor for causing the rotation, or a system of pulleys and gears, gears and ratchets, or pump and hydraulic cylinders for raising and lowering the matrix when the buoyant system is attached to pilings or posts, and the like.

It is to be understood that the periodic and repetitive basis for bringing the vegetation into and out of contact with the water, can mean, for example, that the water-contacting means causes the matrix to be lowered relative to the surface of the water so that a portion of the root region of the vegetation is contacted with and submerged in the water. This contacting period can be of a duration of time in the range of about 6 to about 12 hours, preferably about 6 hours. The contacting period is followed by a drying period in the duration of time in the range of about 6 to about 12 hours, preferably about 6 hours, when the water-contacting means causes the matrix to be raised relative to the water's surface so that a portion of the root region of the vegetation is lifted out of the water. This cycle of periodic contacting and drying of the vegetation's root region is repeated in the range of about 1 to about 24 times per any 24 hour period, with repetition 2 times per 24 hours being most preferred.

The automated controller for controlling the cycle time of the water-contacting means can comprise one or more electronic and/or battery-operated timers. Such timers can control, for example, the activation and deactivation of any compressors, motors and/or valves which comprise the buoyant system. The automated controller may also comprise appropriate electronic devices which may include computer systems as appropriate. It is to be understood that the automated controller of this invention may also comprise an extensive network of environmental and scientific sensors for sensing such conditions as water and/or air temperature, water salinity, water pH, water conductivity, water conductance and other weather conditions. Once these sensors have obtained the relevant data, such data may be stored in a computer, displayed onsite or offsite, incorporated into the computer logic which may govern the output of the controller, and/or transmitted to other locations as desired. The automated controller can be located integral to or attached to the buoyant system or any of its component elements, or the controller may be located at any desirable location, such as, on the bank of the water body or on an adjacent floating barge. Power sources for components of the automated controller and water-contacting means can include, but are not limited to, batteries, solar power, wind power, conventional electrical hook-ups, where available, and electrical generators, or any equivalent electrical source to these.

While in a preferred embodiment of the invention, the buoyant system can be free-floating on the water body, in other preferred embodiments of the invention, at least one buoyant system can be anchored by an anchor to either a bank of the body of water, to the floor of the water body, or both, so that the lateral movement of the buoyant system on the body of water is restricted. Thus, the aquatic vegetation cultivated during practice of this invention is maintained in substantially the same location over time. The term anchor, as used herein, means any device, apparatus or system for restricting the lateral movement of the buoyant system and can include, for example, chains, ropes, cables, wires, lines, tethers and the like attached to pilings, stakes, posts and the like, embedded in the bank or the water floor. Materials of construction for the anchor can include, for example, natural and synthetic rope-making material, metals, plastics and the like. Materials of construction for the stakes and so forth can include, for example, wood, metal, plastic and the like. In all instances, the materials selected are preferably those which withstand exposure to water and harsh weather conditions.

The ballast tank of this invention can be of any suitable shape and material. Such materials for construction of the ballast tank can include, but are not limited to, metal, fiberglass, plastic and the like.

Linking means for connecting a plurality of buoyant systems together on an open body of water can include, for example, chains, ropes, cables, wire, tethers, and the like constructed of a wide variety of materials such as, for example, metal, plastic, natural products such as cotton or hemp, and the like.

Another embodiment of the present invention relates to methods of restoring aquatic vegetation to marshland containing one or more oil field canals which have been dredged, the dredged soils having been placed on the sides of the canals to form spoil banks. The spoil banks restrict the normal ebb and flow of the tides in the marshlands with deleterious effect on the vegetation. In the practice of an embodiment of this invention, a plurality of buoyant systems of this invention with Spartina alterniflora grass deposited on the matrix material are floated in the canals and properly anchored in place. The grass will grow to fill in the matrix due to the accelerated redox reactions brought about by the cycling of the raising and lowering of the root regions. Natural “litterfall” of leaves will fall from the grasses and begin to collect in the mud at the bottom of the canals. Likewise the grass can be mowed and the cut grass mulched into the canal so that the ultimate goal of filing the canal with biomass is accomplished. Most of the components of the buoyant systems will then be removed to leave the “floton” or biomass of healthy grass in place. When the spoil banks are also removed, the healthy marsh grass will spread over a large area of marsh. In certain applications it may be desirable to anchor the matrix so that the floton does not drift away.

The present invention can also be employed to provide systems and methods for cleaning up aquatic chemical spills and/or leaks, such as oil spills. In such applications, the raising and lowering of the matrix will cause the roots of the vegetation to become coated with the undesirable oil. The repetitive raising and lowering of the vegetation's roots can allow the oil to be exposed to air with resultant, at least partial, evaporation of the more volatile oil fractions. In addition, the roots of the vegetation can be contacted with a desirable amount of certain types of bacteria, such as, Bacillus and Pseudomonas which are known to greatly speed the decomposition of the oil layer to more environmentally-friendly derivatives. Thus, the roots of the vegetation can serve the dual purposes of providing a site for bacterial contact with the oil and a site for evaporation of fractions of the oil. This allows the oil to be degraded and removed more quickly and efficiently than otherwise would be possible.

Another beneficial use of the system of this invention relates to bioremediation of water bodies containing undesirable levels of certain substances, for example, cadmium. The cadmium or other undesirable substance can be bioaccumulated within the vegetation to greatly enhance the ease of removal of the undesirable substance from the water body by harvesting and removing the vegetation after a suitable period of time.

In addition, the buoyant system of this invention can alter the hydrology of the water body in a beneficial manner. The matrices and vegetation can act to maintain a zone of water near the surface of the body of water which is predominantly made up of “fresh water” with low salinity. This fresh water zone can be maintained by one or more buoyant systems during ebb and flow cycles of the tide by slowing the natural run-off of fresh rain water, for example, and thus maintain a zone of predominantly fresh water beneficial to other aquatic life. Water having a much higher salinity can be found in a zone below the predominantly fresh water zone.

Each and every patent or printed publication referred to above is incorporated herein by reference in toto to the fullest extent permitted as a matter of law.

This invention is susceptible to considerable variation in its practice. Therefore, the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

In the ensuing claims, means-plus-function clauses are intended to cover the structures described herein as performing the cited function and not only structural equivalents but also equivalent structures.

That which is claimed is:

1. A buoyant system for growing vegetation on an open body of water which comprises:
(A) flotation apparatus,
(B) a matrix sized and configured to support the vegetation, the matrix being connected to the flotation apparatus,
(C) water-contacting means for raising and lowering the matrix relative to the surface of the water when the system is in use, so that at least a portion of a root region of the vegetation is brought into and out of contact with the water, on a periodic and repetitive basis, during use of the system.

2. A system according to claim 1 further comprising an automated controller for controlling the cycle time of the water-contacting means.

3. A buoyant system according to claim 1 wherein the matrix comprises an open frame and material for supporting the vegetation extending across the frame.

4. A buoyant system according to claim 2 wherein the water-contacting means comprises:
(a) a ballast tank,
(b) a pump, sized and configured to move fluid into and out of (i) the ballast tank, (ii) the flotation apparatus, or (iii) both (i) and (ii).

5. A buoyant system according to claim 2 wherein the vegetation comprises a marsh grass.

6. A buoyant system according to claim 5 wherein the marsh grass is Spartina alterniflora.

7. A buoyant system according to claim 3 further comprising anchoring means for anchoring the buoyant system such that lateral movement of the buoyant system is restricted.

8. A method for restoring aquatic marsh vegetation in situ on an open body of water which comprises:
(A) floating on the body of water at least one buoyant system which comprises at least one flotation apparatus connected to a matrix, sized and configured to support the vegetation, and water-contacting means for raising and lowering the matrix relative to the surface of the water,
(B) suspending marsh vegetation within the matrix, and
(C) periodically and repetitively raising and lowering the matrix relative to the surface of the water by action of the water-contacting means so that a varying level of water is provided to at least a portion of a root region of the vegetation.

9. A method according to claim 8 further comprising controlling the cycle time of the water-contacting means with an automated controller.

10. A method according to claim 8 further comprising restricting lateral movement of the buoyant system on the body of water by attachment of the buoyant system to means for anchoring the buoyant system to (i) one or more banks of the body of water, (ii) the floor of the body of water, or (iii) both (i) and (ii).

11. A method for restoring aquatic marsh vegetation in situ on an open body of water which comprises:
(A) disposing vegetation within one or more of the matrices of a plurality of buoyant systems, each of the buoyant systems being according to claim 1,
(B) linking together on the body of water the plurality of buoyant systems, and
(C) anchoring one or more of the systems to (i) one or more banks of the body of water, (ii) the floor of the body of water, or (iii) both (i) and (ii).

12. A method according to claim 11 further comprising controlling the cycle time of the water-contacting means with an automated controller.

13. A method according to claim 12 further comprising removing the plurality of buoyant systems except for the matrices and vegetation such that the aquatic marsh vegetation is left floating in the body of water.

14. A method according to claim 13 wherein the vegetation comprises a marsh grass.

15. A method according to claim 14 wherein the marsh grass is Spartina alterniflora.

16. A method according to claim 11 further comprising removing at least one of the plurality of buoyant systems except for the matrix and vegetation such that the aquatic marsh vegetation is left floating in the body of water.

17. A method according to claim 16 further comprising removing at least a portion of at least one bank.

18. A method according to claim 17 wherein the vegetation comprises a marsh grass.

19. A method according to claim 18 wherein the marsh grass is Spartina alterniflora.
